(19) United States
(12) Patent Application Publication
(10) Pub. No.: US 2006/0092152 A1
(43) Pub. Date: May 4, 2006

(54) Display apparatus and control method thereof

(75) Inventors: Mi-sook Jang, Suwon-si (KR); Geun-sam Yang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd.

(21) Appl. No.: 11/203,099

(22) Filed: Aug. 15, 2005

(30) Foreign Application Priority Data
Oct. 30, 2004 (KR) 2004-0087601

(51) Int. Cl. G09G 5/00

(52) U.S. Cl. 345/211

(57) ABSTRACT

A display apparatus that can detect the type of video signal source connected to the display apparatus and provide display identification data according to the type of the video signal source, and a control method. The display apparatus includes: first and second data storages to store first and second display identification data therein; a terminal to supply power to the first and second data storages; a connector to which a video signal source is connected; a type detector to detect the type of the video signal source through one or more pins of the connector; and a switch to selectively supply power from the power supplying terminal to either the first data storage or the second data storage according to detection results of the type detector.

### CROSS-REFERENCE TO RELATED APPLICATIONS

This application claims the benefit of Korean Patent Application No. 2004-0087601, filed on Oct. 30, 2004, in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof, in which power is selectively supplied to either a first data storage or a second data storage according to the type of a video signal source connected to a connector.

2. Description of the Related Art

One of the international organizations for standardization, the Digital Display Working Group (DDWG), has proposed a digital visual interface (DVI), and the DVI has been adopted as international standard. As a result, various display apparatuses have been developed to receive a digital video signal from a computer.

Currently, there are three types of DVI connector for the DVI, i.e., a DVI-D connector, a DVI-A connector and a DVI-I connector. The DVI-D connector is for transmitting a digital video signal, and the DVI-A connector is for transmitting an analog video signal.

Further, the DVI-I connector is compatible with an analog video signal to address the problem that a display apparatus requires a separate connector, e.g., a D-Sub connector, to receive an analog video signal. FIG. 1 illustrates such a DVI-I connector.

Meanwhile, the computer reads extended display identification data (EDID) information stored in a data storage such as an electrically erasable and programmable read only memory (EEPROM) of the display apparatus through a sixth pin and a seventh pin of the DVI connector. Thus, the computer receives information such as optimum resolution, hue or the like of the display apparatus, and is set to achieve an optimum environment for the display apparatus. Therefore, it is possible to implement a plug and play function. Here, the EDID information and data communication between the computer and the display apparatus are standardized by the EDID according to the Video Electronics Standards Association (VESA).

However, in the conventional display apparatus, the DVI connector for the DVI has three types as described above, but is standardized to use only the sixth pin and the seventh pin for transmitting the EDID information, so that the EDID information is not suitably transmitted according to the type of connected DVI connector.

Particularly, in the case of the DVI-I connector, the DVI-I connector is set to receive both the analog video signal and the digital video signal from a graphic card of the computer, but is set to transmit only one of the analog EDID information and the digital EDID information regardless of the type of the graphic card. As a result, the computer cannot receive correct information from the display apparatus, and thus cannot transmit an optimum video signal to the display apparatus.

### SUMMARY OF THE INVENTION

Accordingly, it is an aspect of the present invention to provide a display apparatus and a control method thereof, which can detect a type of a video signal source connected to the display apparatus and provide display identification data according to the type of the video signal source.

The foregoing and/or other aspects of the present invention are also achieved by providing a display apparatus comprising a first data storage to store first display identification data therein; a second data storage to store second display identification data therein; a power supplying terminal to supply power to the first data storage and the second data storage; a connector having a plurality of pins to which a video signal source is connected; a type detector to detect a type of the video signal source through at least one of the plurality of pins provided in the connector; and a power switch to selectively supply the power from the power supplying terminal to either the first data storage or the second data storage according to detection results of the type detector.

According to an aspect of the present invention, the first display identification data and the second display identification data include analog display identification data and digital display identification data, respectively.

According to an aspect of the present invention, the analog display identification data and the digital display identification data satisfy an extended display identification data (EDID) specification of video electronics standards association (VESA).

According to an aspect of the present invention, the connector comprises a DVI-I connector.

According to an aspect of the present invention, the type detector detects the type of the video signal source through at least one pin of the DVI-I connector assigned for a ground when the DVI-I connector receives a digital video signal from the video signal source.

According to an aspect of the present invention, the display apparatus further comprises a power supply to supply the power to the display apparatus, wherein the power supplying terminal either supplies the power from the video signal source through a predetermined pin of the connector or the power from the power supply to the first data storage or the second data storage.

The foregoing and/or other aspects of the present invention are also achieved by providing a method of controlling a display apparatus comprising first and second data storages to respectively store first and second display identification data therein, the method comprising detecting a type of a video signal source through one of pins provided in a connector to which the video signal source is connected; and supplying power to either the first data storage or the second data storage according to detection results.

According to an aspect of the present invention, the first display identification data and the second display identification data include analog display identification data and digital display identification data, respectively.

According to an aspect of the present invention, the analog display identification data and the digital display identification data satisfy an extended display identification data (EDID) specification of the Video Electronics Standards Association (VESA).

### BRIEF DESCRIPTION OF THE DRAWINGS

The above and/or other aspects and advantages of the present invention will become apparent and more readily appreciated from the following description of exemplary embodiments, taken in conjunction with the accompanying drawings of which:

FIG. 1 illustrates a configuration of a general DVI-I connector;

FIG. 2 is a control block diagram of a display apparatus according to an embodiment of the present invention;

FIG. 3 illustrates a pin structure of a DVI-I connector according to an embodiment of the present invention; and

FIG. 4 is a circuit diagram of a type detector and a power switch of the display apparatus according to an embodiment of the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

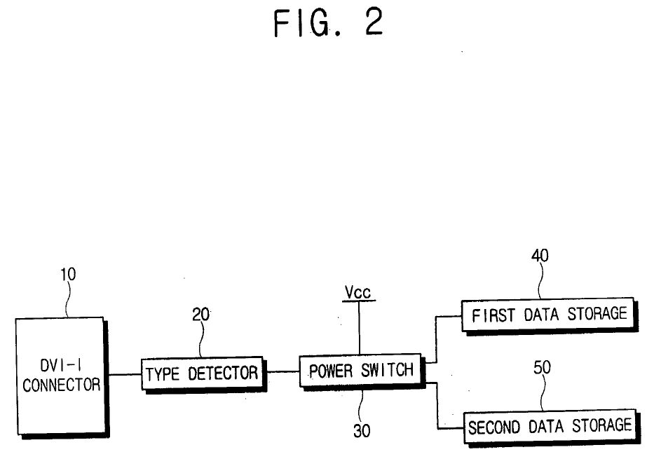

As shown in FIG. 2, a display apparatus according to an embodiment of the present invention comprises a first data storage 40, a second data storage 50, a connector (DVI-I connector 10), a type detector 20, and a power switch 30.

The first data storage 40 stores first display identification data. Further, the second data storage 50 stores second display identification data. Here, various readable and writable memories, for example, an EEPROM can be employed as the first and second data storages 40 and 50.

According to an embodiment of the present invention, the first display identification data is identification data about an analog display, and the second display identification data is identification data about a digital display.

According to an embodiment of the present invention, the first display identification data and the second display identification data have a data structure to satisfy an EDID specification of the VESA.

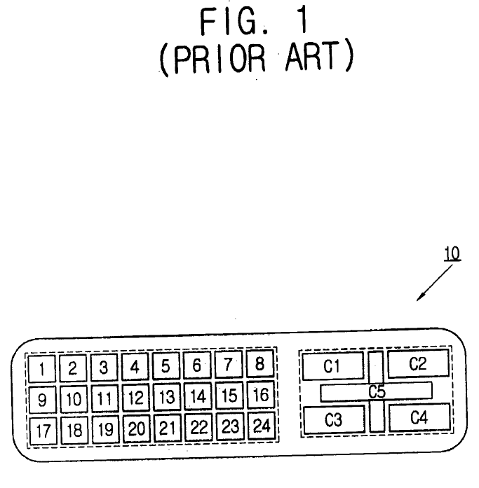

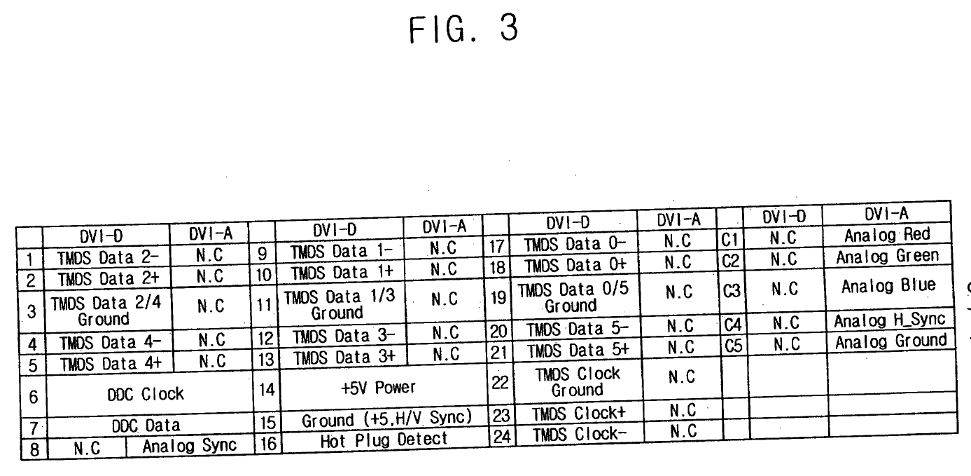

The connector is connected with a video signal source such as a computer, and receives a video signal from the video signal source. According to an embodiment of the present invention, the connector employs a DVI-I connector 10 based on an international standard such as a DVI proposed by the DDWG. Here, the DVI-I connector 10 has a pin structure as shown in FIGS. 1 and 3.

The type detector 20 detects the type of the video signal source through one of the pins provided in the DVI-I connector 10. According to an embodiment of the present invention, the type detector 20 can determine the type of the video signal source through one of the pins assigned for a ground when the DVI-I connector 10 shown in FIG. 1 receives the digital video signal. For example, the type detector 20 detects the type of the video signal source on the basis of the electric potential of the third pin.

The power switch 30 selectively supplies power from a power supplying terminal Vcc to either the first data storage 40 or the second storage 50 according to detection results of the type detector 20. For example, when the type detector 20 detects that the video signal source outputting the analog video signal is connected to the DVI-I connector 10, the power switch 30 supplies the power from the power supplying terminal Vcc to the first data storage 40. On the other hand, when the type detector 20 determines that the video signal source outputting the digital video signal is connected to the DVI-I connector 10, the power switch 30 supplies the power from the power supplying terminal Vcc to the second data storage 40. Thus, only one of the first and second data storages 40 and 50 is enabled corresponding to the type of video signal source connected to the DVI-I connector 10, so that the video signal source can read the display identification data corresponding to its own type through the sixth pin and the seventh pin of the DVI-I connector 10.

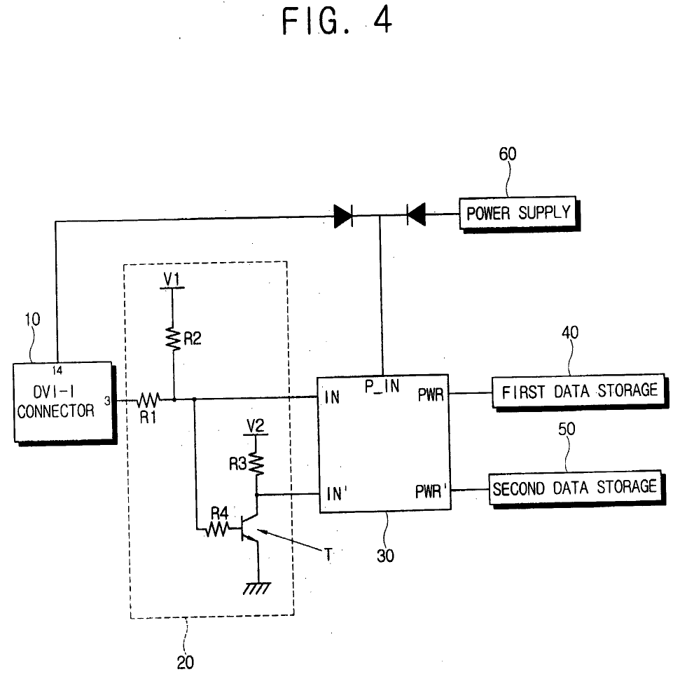

Hereinbelow, the type detector 20 and the power switch 30 according to an embodiment of the present invention will be described in more detail with reference to FIG. 4. In the display apparatus according to an embodiment of the present invention, the type of the video signal source is detected through the third pin of the DVI-I connector 10. As shown in FIG. 3, the third pin of the DVI-I connector 10 is used as a transition minimized differential signaling (TMDS) data 2/4 ground when the DVI-I connector 10 receives a digital video signal, but is disconnected when the DVI-I connector 10 receives an analog video signal.

The power switch 30 comprises a first power output terminal PWR to supply the power to the first data storage 40, a second power output terminal PWR′ to supply power to the second data storage 50, and a power input terminal P_IN connected to the power supplying terminal Vcc and receiving the power. Further, the power switch 30 comprises a first signal input terminal IN and a second signal input terminal IN′ to receive different logical sensing signals (hereinafter, referred to as “first sensing signal” and “second sensing signal”) from the type detector 20.

For example, when the first sensing signal inputted through the first signal input terminal IN has a logical value of ‘1’ and the second sensing signal inputted through the second signal input terminal IN′ has a logical value of ‘0’, the power switch 30 supplies the power from the power input terminal P_IN to the first data storage 40 through the first power output terminal PWR. On the other hand, when the first sensing signal inputted through the first signal input terminal IN has a logical value of ‘0’ and the second sensing signal inputted through the second signal input terminal IN′ has a logical value of ‘1’, the power switch 30 supplies the power from the power input terminal P_IN to the second data storage 50 through the second power output terminal PWR′.

The type detector 20 detects the electric potential of the third pin provided in the DVI-I connector 10, and outputs the first sensing signal and the second sensing signal which are different in logical values. FIG. 4 has a circuit diagram of the type detector 20 and the power switch 30 of the display apparatus according to an embodiment of the present invention. Referring to FIG. 4, resistors R2 and R3 are pull-up resistors to control the logical values of the first and second sensing signals according to the electric potential of the third pin provided in the DVI-I connector 10, and a transistor T inverses the logical values of the first and second sensing signals alternately with each other. Further, resistors R1 and R4 are serial resistors.

With this configuration, when the video signal source outputting a digital video signal is connected to the DVI_I connector 10, the third pin of the DVI-I connector 10 is grounded and has a logical value of ‘0’, so that the first sensing signal inputted through the first signal input terminal IN of the power switch 30 has a logical value of ‘0’. At this time, the logical value of the second sensing signal inputted through the second signal input terminal IN′ is inversed by the transistor T into ‘1’. Thus, the power switch 30 supplies the power from the power input terminal P_IN to the second storage 50 through the second power output terminal PWR′, thereby enabling the second data storage 50. Therefore, the video signal source can read the digital EDID information stored in the second data storage 50 through the sixth pin and the seventh pin of the DVI-I connector 10.

On the other hand, when the video signal source outputting an analog video signal is connected to the DVI_I connector 10, the third pin of the DVI-I connector 10 has a logical value of ‘1’, so that the first sensing signal inputted through the first signal input terminal IN of the power switch 30 has a logical value of ‘1’. At this time, the logical value of the second sensing signal inputted through the second signal input terminal IN′ is inversed by the transistor T into ‘0’. Thus, the power switch 30 supplies the power from the power input terminal P_IN to the first storage 40 through the first power output terminal PWR, thereby enabling the first data storage 40. Therefore, the video signal source can read the analog EDID information stored in the first data storage 40 through the sixth pin and the seventh pin of the DVI-I connector 10.

Here, the power supplying terminal Vcc is provided to supply the power from either a power supply 60 or a fourteenth pin of the DVI-I connector 10 to the first data storage 40 or the second data storage 50 through the power switch 30. Therefore, even though the power is not supplied from the power supply 60 provided in the display apparatus, the first data storage 40 or the second data storage 50 storing the EDID information therein can be enabled by the power supplied from the video signal source through the fourteenth pin of the DVI-I connector.

Further, the power V1, V2 to operate the type detector 20 shown in FIG. 4 can be supplied through the power supply 60 or the fourteenth pin of the DVI-I connector 10.

In the foregoing embodiment, the power switch 30 comprises the first signal input terminal IN and the second signal input terminal IN′ to receive the first sensing signal and the second sensing signal from the type detector 20. Alternatively, the type detector 20 can output one sensing signal, e.g., a sensing signal corresponding to the electric potential of the third pin provided in the DVI-I connector 10. Also, the power switch 30 can selectively supply the power to either the first data storage 40 or the second data storage 50 on the basis of the one sensing signal.

Further, the foregoing logical values of the first sensing signal and the second sensing signal can vary by changing the circuit configuration of FIG. 4, within a range appreciated by those skilled in the art, thereby performing the same function as the present invention provides.

In the foregoing embodiment, the type detector 20 detects the type of the video signal source through one of the pins provided in the DVI-I connector 10 assigned for the ground when the DVI-I connector 10 of FIG. 3 receives the digital video signal. Alternatively, the type detector may detect the type of the video signal through another pin having different electric potential, e.g., through a pin C5 when the DVI-I connector receives a digital video signal and an analog video signal.

Thus, there are provided the type detector 20 to detect the type of the video signal source through at least one of the pins provided in the DVI-I connector 10; and the power switch 30 to selectively supply the power to either the first data storage 40 or the second data storage 50 according to the detection results of the type detector 20, so that the type of the video signal source connected to the DVI-I connector 10 is detected, thereby transmitting the display identification data corresponding to the type of the video signal source to the video signal source.

As described above, the present invention provides a display apparatus and a control method thereof, in which a type of a video signal source is detected and display identification data corresponding to the detected type of the video signal source is transmitted to the video signal source, thereby allowing the display apparatus to optimally display a picture.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus comprising:
a first data storage to store first display identification data therein;
a second data storage to store second display identification data therein;
a power supplying terminal to supply power to the first data storage and the second data storage;
a connector having a plurality of pins to which a video signal source is connected;
a type detector to detect a type of the video signal source through at least one of the plurality of pins provided in the connector; and
a power switch to selectively supply the power from the power supplying terminal to either the first data storage or the second data storage according to detection results of the type detector.

2. The display apparatus according to claim 1, wherein the first display identification data and the second display identification data include analog display identification data and digital display identification data, respectively.

3. The display apparatus according to claim 2, wherein the analog display identification data and the digital display identification data satisfy an extended display identification data (EDID) specification of the Video Electronics Standards Association (VESA).

4. The display apparatus according to claim 2, wherein the connector comprises a DVI-I connector.

5. The display apparatus according to claim 4, wherein the type detector detects the type of the video signal source through at least one pin of the DVI-I connector assigned for a ground when the DVI-I connector receives a digital video signal from the video signal source.

6. The display apparatus according to claim 1, further comprising a power supply to supply the power to the display apparatus, wherein the power supplying terminal either supplies the power from the video signal source through a predetermined pin of the connector or the power from the power supply to the first data storage or the second data storage.

7. A method of controlling a display apparatus comprising first and second data storages to respectively store first and second display identification data therein, the method comprising:
detecting a type of a video signal source through one of pins provided in a connector to which the video signal source is connected; and
supplying power to either the first data storage or the second data storage according to detection results.

8. The method according to claim 7, wherein the first display identification data and the second display identification data include analog display identification data and digital display identification data, respectively.

9. The method according to claim 8, wherein the analog display identification data and the digital display identification data satisfy an extended display identification data (EDID) specification of the Video Electronics Standards Association (VESA).
